(19) United States
(12) Patent Application Publication
(10) Pub. No.: US 2007/0055441 A1
(43) Pub. Date: Mar. 8, 2007

(54) SYSTEM FOR ASSOCIATING PRE-RECORDED IMAGES WITH ROUTING INFORMATION IN A NAVIGATION SYSTEM

(75) Inventors: Jamie E. Retterath, Eden Prairie, MN (US); Robert A. Laumeyer, Eden Prairie, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: Facet Technology Corp., Eden Prairie, MN (US)

(21) Appl. No.: 11/464,360

(22) Filed: Aug. 14, 2006

Related U.S. Application Data
(60) Provisional application No. 60/707,710, filed on Aug. 12, 2005.

(51) Int. Cl. G01C 21/00

(52) U.S. Cl. 701/200; 340/995.24

(57) ABSTRACT

A vehicle navigation system uses prerecorded intersection images to more quickly and efficiently acquaint the driver with approaching intersections and other points of interest as part of a navigation system. The pre-recorded images are recorded, selected and processed with header information that associates the selected landmark images of approaching intersections and other points of interest to spatial nodes based on runs defined by routing information in the navigation system. The runs defined by the routing information correlate to a path or road segment to be traveled with the spatial nodes defining a transition point from one run to another, such as a roadway intersection where a turn is required to follow the routing information. Preferably, a multiplicity of recorded images are analyzed from a road segment to select a set of images that correspond to a plurality of distances from an approaching intersection, for example, where the selected images include a view of relevant visual information, such as road sign images, associated with the intersection.

### RELATED APPLICATION

The present application claims the benefit of U.S. Provisional Application No. 60/707,710, filed Aug. 12, 2005, which is incorporated herein in its entirety by reference.

### FIELD OF THE INVENTION

The present invention relates generally to the field of data processing and communication systems for route determination and navigation systems utilizing a map database and map display and having audio or visual route guidance or intersection turn guidance. More specifically, the present invention relates to a method and apparatus for using pre-recorded images with pre-processed header information that associates landmark images to spatial nodes based on runs defined by routing information in a navigation system.

### BACKGROUND OF THE INVENTION

Vehicle navigation systems that can automatically determine driving directions from a starting point to a destination are well known. The typical format of these driving directions is to describe travel along a defined roadway for a certain distance, followed by some driver action (usually a turn) at a defined intersection. Once these directions are established, it is up to the driver to carry them out with little, if any, assistance from the navigation system. On-board navigation systems located in the vehicle generally have the ability to notify a driver that a particular intersection was missed, but this simply allows a driver to correct a navigation mistake after it has occurred. Off-board navigation systems, such as Internet-based direction programs like MapQuest® or standalone direction programs available in many vehicles often can only produce a displayed map showing the route on a map and listing the specific actions to be taken by the driver at certain intersections.

It is common for directions generated by either on-board or off-board navigation systems to include distances to upcoming intersections where drivers are required to perform actions. Often times, however, these distances are not accurate enough for precise location of the intersection by the driver. Conditions like heavy traffic, multiple intersection choices, commercial sign clutter, and poor lighting can contribute to driver confusion at key decision points. Route planning features of navigation systems can usually give good instructions for drivers, but the visual route information can only be plotted on a two-dimensional road map. Drivers are often unfamiliar with the terrain being navigated while following directions. It is also difficult to show foliage, signage, lighting structures, and other visual cues that might assist in driver navigation on a two-dimensional road map.

Various attempts have been made to overcome these limitations with vehicle navigation systems. U.S. Pat. No. 5,396,431 describes an on-board vehicle navigation system that shows the present vehicle location superimposed on an on-board display of an aerial photograph. U.S. Pat. No. 5,995,903 and PCT Publ. No. WO/9954848 describe vehicle navigation systems that generate or render a three-dimensional virtual image of the route being traveled by a vehicle from data stored in a terrain database unit or a digitized base map. U.S. Pat. Nos. 6,076,041, 6,078,865 and 6,119,066 describe on-board vehicle navigation systems that provide supplemental information to a driver for selected intersections. In U.S. Pat. Nos. 6,076,041 and 6,119,066, more detailed or enlarged views of the base map intersection are provided that have navigation aids superimposed on these maps. In U.S. Pat. No. 6,078,865, cues are provided to a driver based on landmark data associated with intersections that will be encountered when following the driving directions and how to navigate through these intersections. The landmarks are displayed on a two-dimensional road map using a defined set of icons to represent different landmarks. U.S. Pat. Nos. 5,544,060 and 6,122,593 describe vehicle navigation systems that provide a preview of the route or path selected to a destination where the preview is displayed as a portion of the roadmap or a list of road names.

Some attempts have been made to incorporate photographic or video images in conjunction with vehicle navigation systems. U.S. Pat. No. 4,992,947 describes an early vehicle navigation system that generated guidance information based on road number data structure, and included the display of photographs of intersections stored in the data structure according to photograph numbers. U.S. Pat. No. 5,115,398 describes another early on-board vehicle navigation system that superimposes directional instructions onto a real-time video image acquired by an on-board camera. U.S. Pat. No. 6,199,014 describes a navigation system that utilizes route vectors matched to a database of photographic images, wherein the images were stored with a corresponding geographic location of the photographs along with the direction of view of the representation of the photograph. U.S. Pub. No. 2006/0004512A1 describes a navigation system targeted for vehicle or pedestrian use that displays and overlays guidance information on available images corresponding to the current location and direction of the navigation system as it travels along a calculated route. The processing and recording of images as described in this application are maintained in the same routing database employed by the navigation system to provide the user with various navigation features and functions, and the routing database must be accessed each time an image is to be displayed.

An Internet navigation system that has attempted to incorporate photographic images in conjunction with directions is the Blockview™ feature of the standalone direction program at http://maps.a9.com that displays photographs for a very limited number of locations in a few selected cities. When the segments of a calculated route are returned by this website, the user must select a particular segment to display its corresponding image, if available. At most two sets of images corresponding to the two sides of a road segment can be displayed, and they are not shown from the perspective of the direction of travel.

Traditional on-board navigation systems have utilized digital map information coupled to the navigation and display system, the storage means consisting of a CD-ROM, FLASH memory, or DVD. Due to the size of image repositories, systems that have added the capability of prerecorded images have needed to associate the on-board map information to an off-board image library. The bandwidth limitations of on-board navigation systems have made image usage a difficult problem to solve.

Various attempts have been made to overcome these limitations with vehicle navigation systems. U.S. Pat. No. 6,621,423 describes a system that utilizes a map database coupled to a visual map device. U.S. Pat. No. 6,671,619 describes a navigation system with integrated storage, control and display units for guiding a vehicle along a route. U.S. Pat. No. 6,868,169 describes a system for spatially indexing a number of images. U.S. Pat. No. 6,903,763 describes a system for capturing images along a route and recording them to a removable storage medium.

Although there have been improvements in navigation systems over the years, it would be desirable to provide a navigation system that could more efficiently acquaint a driver with image information about intersections and other landmarks along a route being navigated that was more efficient and effective in terms of the storage and retrieval of pre-recorded image information that may be useful to acquaint users with an intended navigation route.

### SUMMARY OF INVENTION

The present invention uses pre-recorded images to more efficiently acquaint a user with approaching intersections and other points of interest as part of a navigation system. The pre-recorded images are recorded, selected and processed with header information that associates the selected landmark images of approaching intersections and other points of interest to spatial nodes based on runs defined by routing information in the navigation system. The runs defined by the routing information correlate to a path or road segment to be traveled with the spatial nodes defining a transition point from one run to another, such as a roadway intersection where a turn is required to follow the routing information. Preferably, the present invention analyzes a multiplicity of recorded images from a road segment to select a set of images that correspond to a plurality of distances from an approaching intersection, for example, where the selected images include a view of relevant visual information, such as road sign images, associated with the intersection.

In a preferred embodiment, an image database is generated having multiple prerecorded images captured from traversing along a roadway system. The image database is processed to contain multiple prerecorded images that correspond to landmarks, e.g., intersections and other points of interest, and preferably include at least one image taken from a non-aerial perspective of each road segment approaching those landmarks. Preferably, a series of images from the perspective of each road segment are stored in the image database, with the series representing images of the intersection taken at different distances from the intersection. In one embodiment, GPS coordinates are used to link the image database to a roadmap database for use in an on-board vehicle navigation system. As the on-board vehicle navigation system is approaching an intersection, for example, the navigation system requests and displays the prerecorded landmark images for that intersection corresponding to the perspective of the road segment from which the intersection is being approached preferably based on pre-processed information stored in the header information of a previous landmark image. Route navigation information can be superimposed on the prerecorded landmark images or supplied separately.

In another embodiment, a user can selectively display images from the image database corresponding to a route to be navigated. In this embodiment, an off-board navigation system selects a route to be navigated and prerecorded images for selected landmark locations along the direction of travel of this route are displayed or provided to the user based on pre-processed information stored in the header information of the landmark images in order to acquaint the user with the appearance of important points along the selected route.

The present invention permits separate processing of the selected route and the prerecorded images such that prerecorded images for a given route can be changed, modified or deleted without requiring any change in the manner in which the selected route information is generated. In this way, a single image database can include a multiplicity of images that are linked, for example, in different ways to present different sequences of prerecorded images. The different sequence of prerecorded images can correspond to different routes or route segments, or could represent images taken at different times of day or different seasons of the year. In one embodiment, the sequence of prerecorded images could include different landmarks or generated portions of images that were selectively inserted into the sequence of prerecorded images to represent an advertiser or sponsor for a given period of time or for a given set of routes.

The present invention allows drivers in the process of following destination directions from a navigation system to have greater success (make fewer wrong turns and have fewer missed turns) and create safer roadways by having access to landmark images. For every intersection where a driver action is required, for example, the present invention can provide the driver with a near, intermediate, and far image of the approaching intersection. Since a simple crossing of two roads has four possible views of the intersection (corresponding to the four directions of vehicle travel), the present invention can produce the images that are relevant to the perspective of the vehicles proposed direction of travel. Drivers are thus able to compare the intersection images with their upcoming views of the actual roadway to acquaint themselves with the intersection and determine proper actions to be taken at that intersection.

In a preferred embodiment, users can experience virtual travel from a source point to a destination. Systems that provide turn-by-turn directions from a routable network of roadways are well known. These systems can be further enhanced by allowing users to “see” the actual route specified by the routing software by showing the sequence of landmark images along the described route that are associated with given spatial nodes.

This invention describes a collection and presentation method of actual imagery from roadways in such a way that centralized and co-located image repositories can rapidly display landmark images along defined navigation routes. By selectively associating the landmark images with pre-processed header information, the present invention permits the landmark images to be decoupled from the navigation route information. The decoupled information approach permits rapid updating and distribution of image information for use on various clients, including light clients like cell phones, personal digital assistants (PDAs), and satellite radios. Furthermore, the decoupled approach to vehicle navigation of the present invention allows for better utilization of the limited-bandwidth network connections available to on-board navigation systems.

In a preferred embodiment, off-board users can further acquaint themselves with critical information regarding a navigation route. For example, a potential buyer of residential real estate can utilize an Internet-based system to view potential properties. In conjunction with this system, images of all roadways can be provided to the user. If, for example, the user wanted to explore the route their children would traverse from the target property to their elementary school, the user could define the origin as the target property, define the destination as the elementary school, and allow the application to take the user on a virtual walk to the school.

In a preferred embodiment, the rate at which the landmark images are displayed can be easily changed. If, for example, a user wanted to make a very rapid pass over a desired route, the application can make adjustments to the image stream in order to best use the available bandwidth over the network. The application could display only selective images along the route, thus allowing the user to move through the route at a faster rate. Alternatively, the application could access more highly compressed versions of the images. While highly compressed images exhibit somewhat diminished image quality, users moving through the imagery at higher rates of speed would not notice the image degradation.

In a preferred embodiment, the rate at which landmark images are displayed can be tightly controlled. Assume that a user wishes to traverse a roadway at the posted speed of the roadway. The application could ensure that successive images are displayed at a rate that moves the user through the virtual environment at the posted roadway speed, or at any other speed defined by the user.

In a preferred embodiment, the database containing the landmark images are selected and processed on a periodic basis in an offline manner. For example, each month new images and new spatial nodes could be defined and introduced into the landmark image database, which would then be made available in an online or networked arrangement to respond to image requests. In one version of this embodiment, the availability of the landmark images for a given portion of a navigation system could be supported or underwritten by one or more sponsors in each for selected landmark images associated with that sponsor being included in the landmark image database for that period of time. For example, a restaurant chain could sponsor an image available for a given month and roadside images of that restaurant could be included as a portion of the images of interest along given road segments where the restaurants would be located or proximate to a road segment of a navigation route.

### BRIEF DESCRIPTION OF THE DRAWINGS

FIG. 1 is an overall schematic diagram of a preferred embodiment of how images are acquired for the present invention.

FIG. 2 displays an overhead view of a road network with lanes of travel in both directions.

FIG. 3 shows routes traversed by an image capture vehicle over the road network.

FIG. 4 displays the image capture points for the bi-directional road network.

FIG. 5 shows a start location and a destination for a virtual drive-through or for a route in a navigation system.

FIG. 6 shows the format for the Image Identifier.

FIG. 7 displays the Image Header Data Structure Format.

FIG. 8 shows the Spatial Node Header Format.

FIG. 9 displays image selection for a virtual drive-through or for a route in a navigation system.

FIG. 10 is a detailed schematic diagram of a preferred embodiment of how intersection images are processed for the present invention.

FIG. 11 is a flowchart showing how an intersection image database is created.

FIG. 12 is a schematic diagram of how intersection images can be displayed in an on-board vehicle navigation system or via a wireless-connected device.

FIG. 13 is a schematic diagram of how intersection images can be utilized by an off-board navigation system or how a virtual drive-through can be shown on an Internet-connected device.

### DETAILED DESCRIPTION OF THE PREFERRED EMBODIMENTS

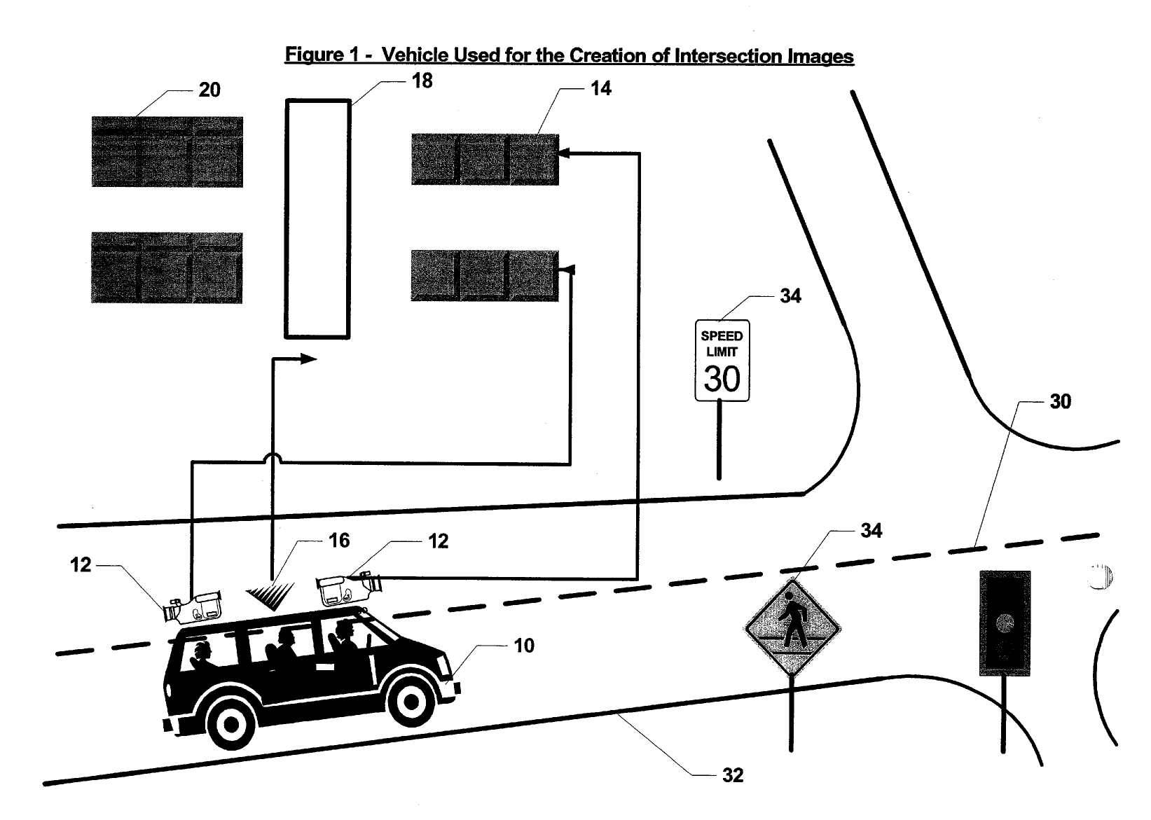

Referring to FIG. 1, a preferred embodiment for how images are obtained and processed as part of the present invention will be described. An acquisition vehicle 10 equipped with one or more cameras 12 generates a series of raw image streams 14 representative of a road or street 32 over which the acquisition vehicle 10 is traveling. For each portion of a roadway system being recorded, the acquisition vehicle 10 is preferably driven in both directions along each road or street 32. In the case of road or streets 32 having multiple lanes in the same direction, imagery may be recorded for each lane. This is preferable in the case of separate left and right turn lanes at intersections. In a preferred embodiment, global positioning satellite (GPS) receiver 16 supplies location information that is combined with the raw image stream 14 by a processor 18 to generate a tagged image stream 20. Alternatively, the tagged image stream 20 may be generated using other types of position indicating information, such as visual position identification or RF triangulation. In another embodiment, individual intersection images may be acquired by use of a digital camera or other means of recording a still image.

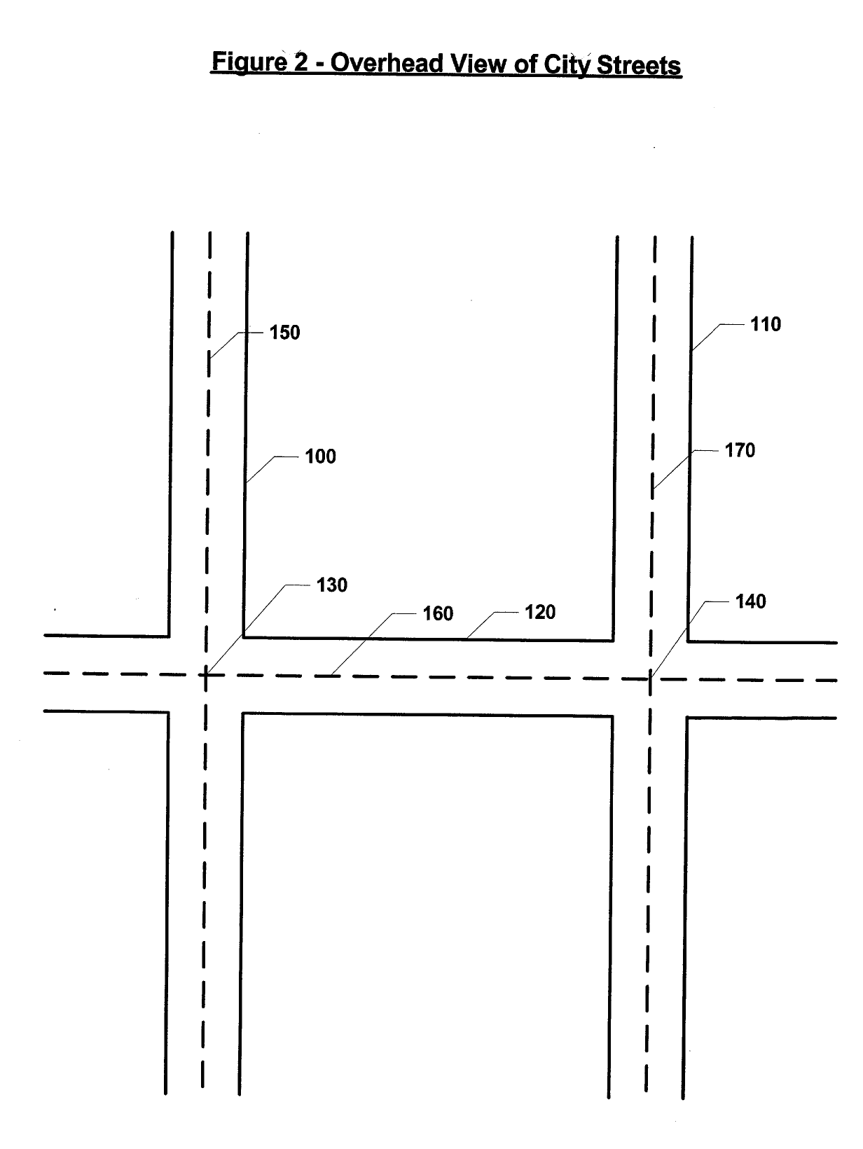

FIG. 2 shows an overhead view of a few blocks within a city over which the image acquisition vehicle 10 has been driven. The leftmost top-to-bottom road 100 and the side-to-side road 120 form an intersection 130. In addition, the rightmost top-to-bottom road 110 and the side-to-side road 120 form another intersection 140. In this embodiment, each road 100, 110, 120 is a two-lane road, with each direction of travel separated by a centerline 150.

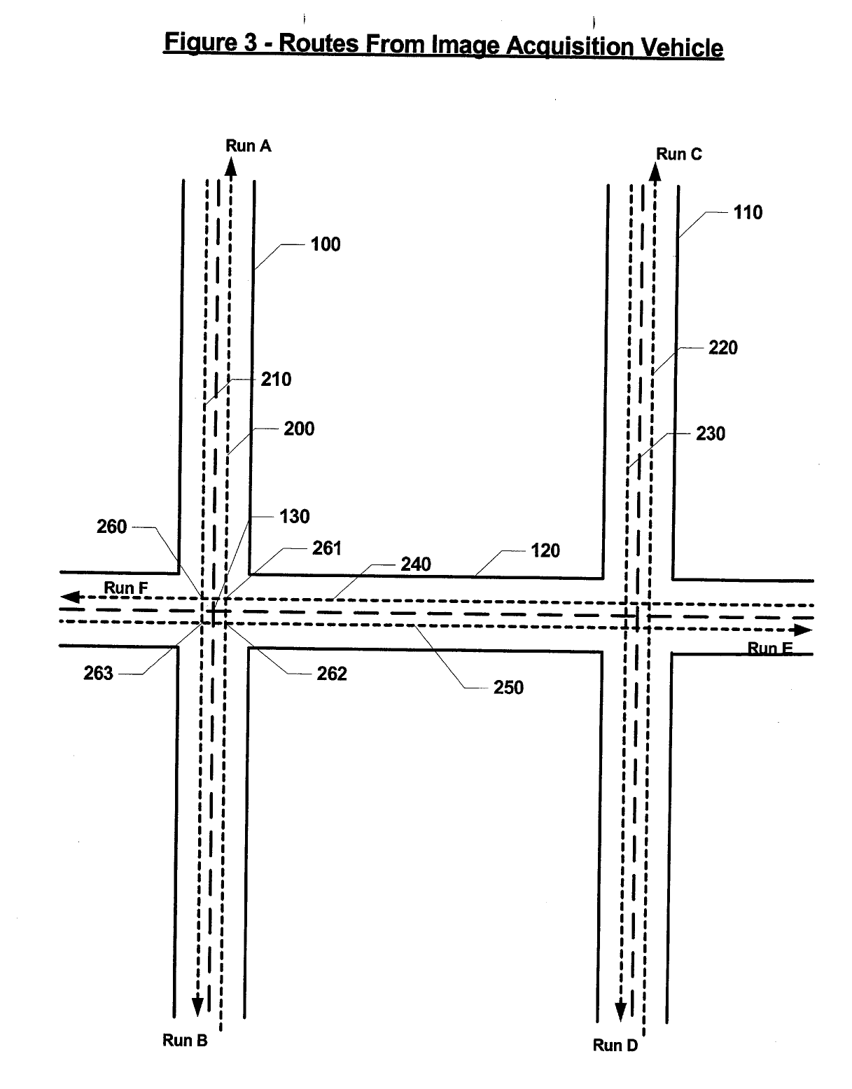

FIG. 3 shows the image capture runs from the vehicle 10 that created imagery for this area. Run A 200 and Run B 210 together provide full image acquisition coverage for the road 100. A “Run” is defined as a sequential collection of tagged images that represent movement of an acquisition vehicle 10 along a defined path. Although FIG. 3 shows runs as straight lines, in practice a run will contain many curves and turns from start to finish. Run C 220 and Run D 230 together provide full image acquisition coverage for road 110. Although road coverage is shown in separate runs, both directions of travel can actually be contained within the same run. For example, two cameras oriented in different directions and on different sides of the vehicle 10 can capture images, the sequence of which is then reversed by processing one of the runs in reverse order. While the image capture runs are shown in FIG. 3 as capturing images at consistent predetermined intervals, it will be recognized that captured images may be captured at different intervals or different frequencies. Run E 250 and Run F 240 together provide full image acquisition coverage for road 120.

For road 100 at intersection 130, there are four runs (A, B, E, F) 200, 210, 240, 250 that correspond to imagery for the intersection 130. There are four points 260, 261, 262, 263 where runs 200, 210, 240, 250 intersect at the intersection 130. A user viewing imagery from Run B 210 as the imagery approaches the intersection 130 will encounter a decision at point 260. The user can turn right and proceed on Run F 240 or they can continue on Run B 210. If the user continues on Run B, they will encounter another decision at point 263. They can either stay on Run B 210, or take a left turn and proceed on Run E 250. The points 260, 261, 262, 263 are called Spatial Nodes since they are points at which a navigation system or a virtual driver can transfer from one run to another run. Spatial Nodes 260, 261, 262, 263 are points where different runs 200, 210, 220, 230, 240, 250 cross each other spatially or are in close proximity to one another and represent road features that allow navigation of a user between the runs. Spatial Nodes 260, 261, 262, 263 can also represent different points in the same run, as long as those points are aligned spatially.

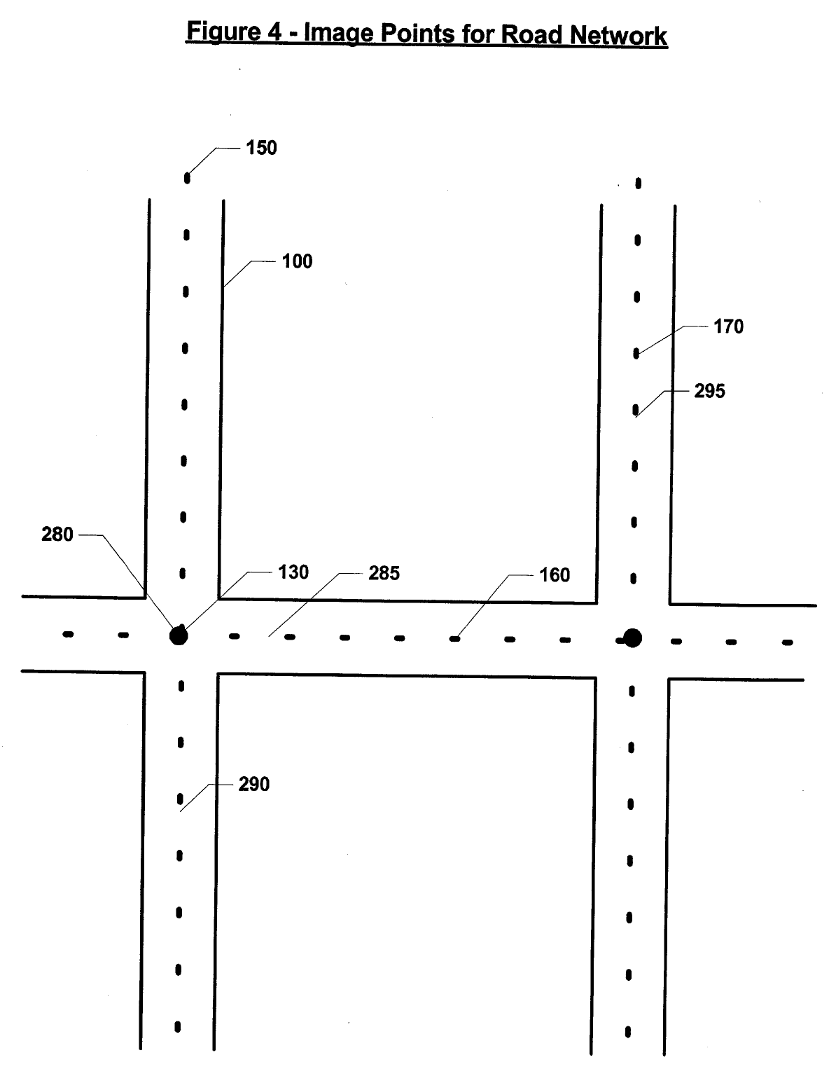

FIG. 4 shows the same road network from FIG. 3, but now the runs 285, 290, 295 have been spatially aligned with the road centerlines 150, 160, 170. This change reduces the number of spatial nodes 280 at the intersection 130 from four to one.

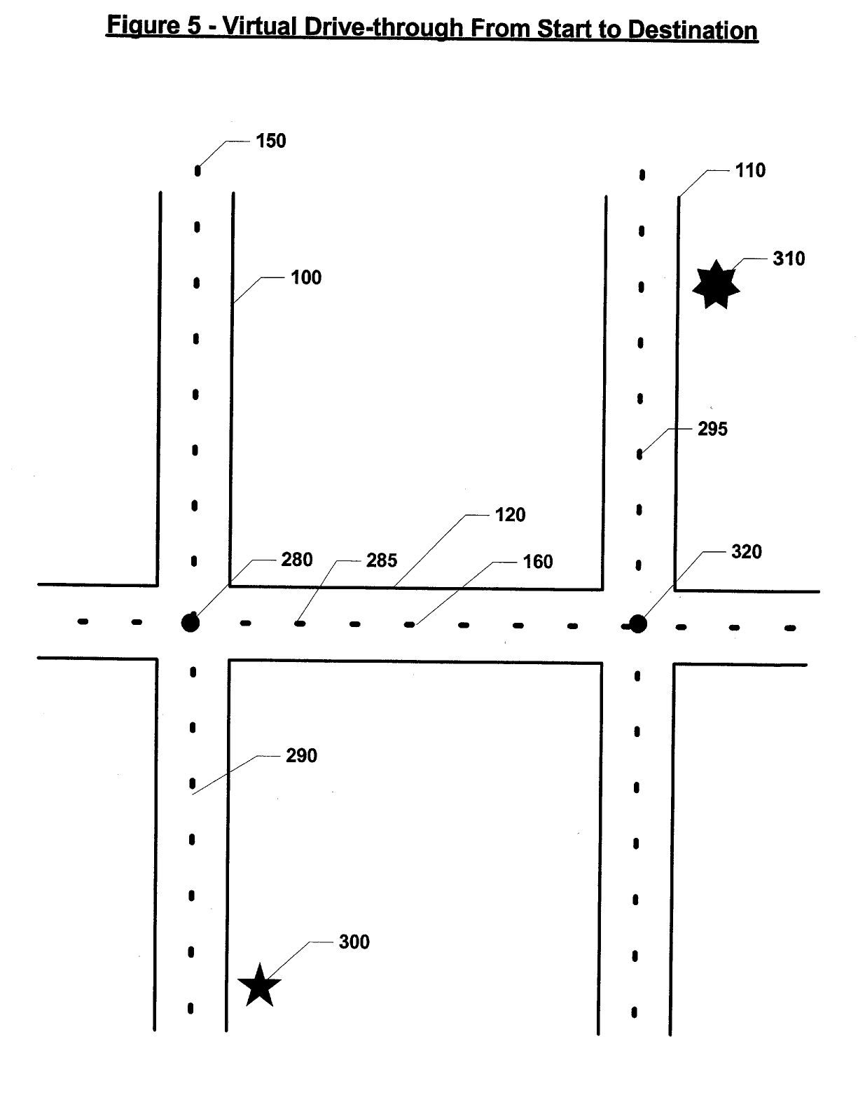

FIG. 5 shows a scenario in a typical navigation application. A user wishes to travel from an origin 300 to a destination 310. The navigation system will typically report to “turn right on Elm Street” and “turn left on Maple Avenue.” If we assume Elm Street is road 120 and Maple Avenue is road 110, the Spatial Nodes 280, 320 will provide decision points at which the image stream will need to switch runs.

Modern image formats make provisions for header information that can consist of non-image data elements that are embedded in the image descriptor data. The invention described herein relies on this image header to embed run information and other related pre-processed information. The preprocessed and embedded run information permits the present invention to limit the number of requests that must be made to the routing database and image database by the navigation system, thus providing the opportunity for better utilization of the lower bandwidth connections between the image database and the navigation system, for example. Images contained in the image database 24 will typically consist of files in the range of 10 kilobytes to 500 kilobytes. An information header in accordance with the present invention would consist of only a few hundred bytes, thereby adding very little transmission overhead to the system. The advantage of making fewer requests of the mapping database 36 and/or image database 24 will clearly outweigh the cost of slightly increasing the image file sizes.

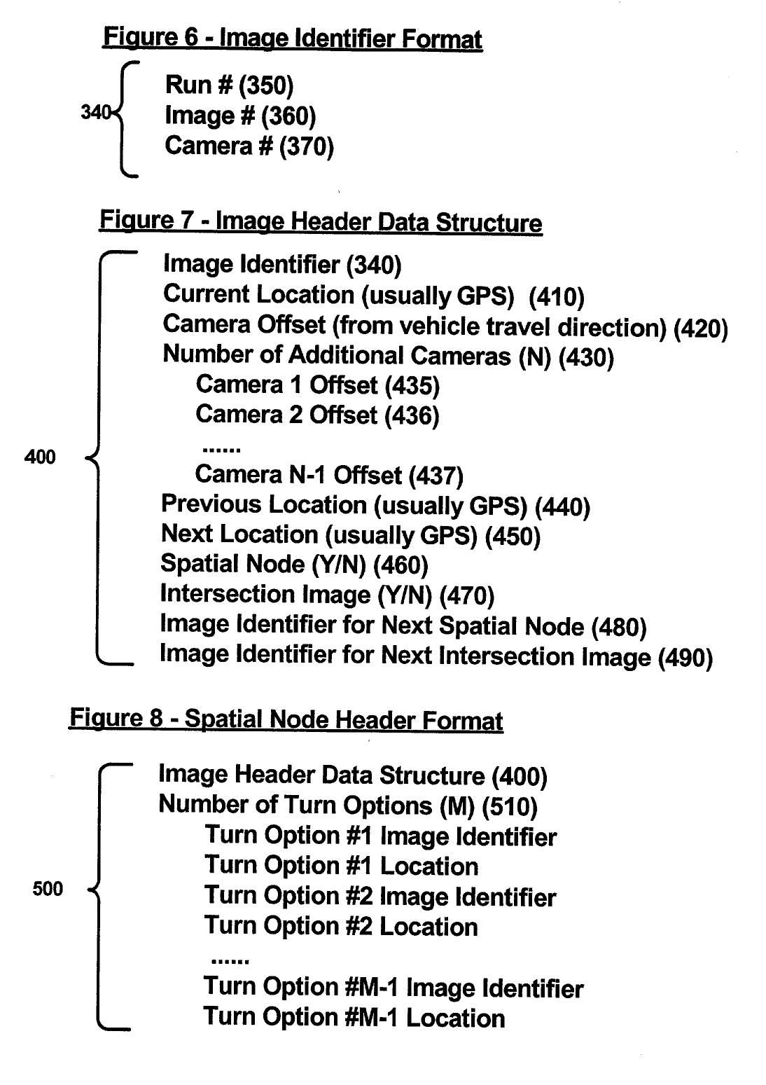

FIG. 6 shows one embodiment of an Image Identifier 340 format that is used to uniquely identify a particular image. Navigation systems and virtual drive-through systems require frequent “decisions” as the user travels from the origin to the destination. For example, a virtual driver may wish to view imagery along a route until a particular landmark is reached. At that point they may wish to retrieve a view of the landmark from a different camera. The header format described herein allows on-the-fly navigation decisions to be made without needing to access the spatial database for every movement.

The Run Number 350 is a unique identifier that specifies the acquisition vehicle 10 along with a date and time stamp. The assumption is that each Run Number 350 is a unique identifier for a set of images. The Image Number 360 will identify a unique capture event within the Run 350. For multi-camera acquisition vehicles 10, each camera 12 preferably will have a unique identifier 370 that will differentiate it from other cameras 12 used on the same vehicle 10 within the same run 350.

FIG. 7 shows one embodiment of the Image Header Data Structure 400. This information is preferably embedded into every image available to the navigation or display system. The Current Location 410 specifies the vehicle 10 location when the image was collected. The Camera Offset 420 specifies the camera 12 location relative to the direction of travel of the vehicle 10. For purposes of the system defined herein, the absolute direction of view of the camera is not needed and is not relevant. Since the image runs follow roadways, the camera's 12 orientation with respect to the vehicle's 10 direction of travel is all that is needed to create the Image Header Data Structure 400 for the prerecorded images associated with a given run.

At each vehicle location it is preferable to have access to other camera views. In one embodiment, the camera numbers and their offsets are specified in a list 435, 436, 437, the length of which is specified in the Number of Additional Cameras 430 field. For each entry in the list 435, 436, 437, the camera number and relative offset are supplied.

The Previous Location 440 and Next Location 450 fields provide access to the vehicle locations for the previous and next images in the stream. The Spatial Node Field 460 specifies whether this vehicle location is a point at which the navigation application can switch to a new run. If the Spatial Node Field 460 is a Yes, the image header contains a Spatial Node Header 500 that specifies the alternate run options along with the appropriate Image Identifiers 340. The Intersection Image Field 470 specifies whether this image has been previously tagged as an intersection image. Further modifications can be made that could specify pixel locations within the image onto which directional arrows could be superimposed.

For intermediate landmark images (i.e., images along a route that are not Spatial Nodes and are not tagged as intersection images), it is often useful to know the location of the next Spatial Node and/or the next Intersection Image. The preferred embodiment of the Image Header Data Structure 400 provides two fields for identifying these points, called the Next Spatial Node 480 and the Next Intersection Image 490. Both of these fields are Image Identifier fields.

Alternate data structures are possible that will yield further performance improvements. For example, the Next Spatial Node 480 field and the Next Intersection Image 490 field can be expanded to longer lists of spatial nodes and intersection images as well as landmark images. This expansion would allow the application to make pre-fetch requests to the image server, thus ensuring faster access to images being supplied over networks that have slower connection speeds. Such longer lists of spatial nodes and intersection images and landmark images can also be used to selectively skip images in the list depending, for example, upon the speed of the connection or the speed of the vehicle containing the navigation system. In an off-board embodiment, the number of skipped images could be varied depending upon the relative distance from a given image to the next spatial node so as to provide different levels of resolution for a “drive-thru” experience, i.e., more images displayed closer to a spatial node and fewer images displayed in between spatial nodes.

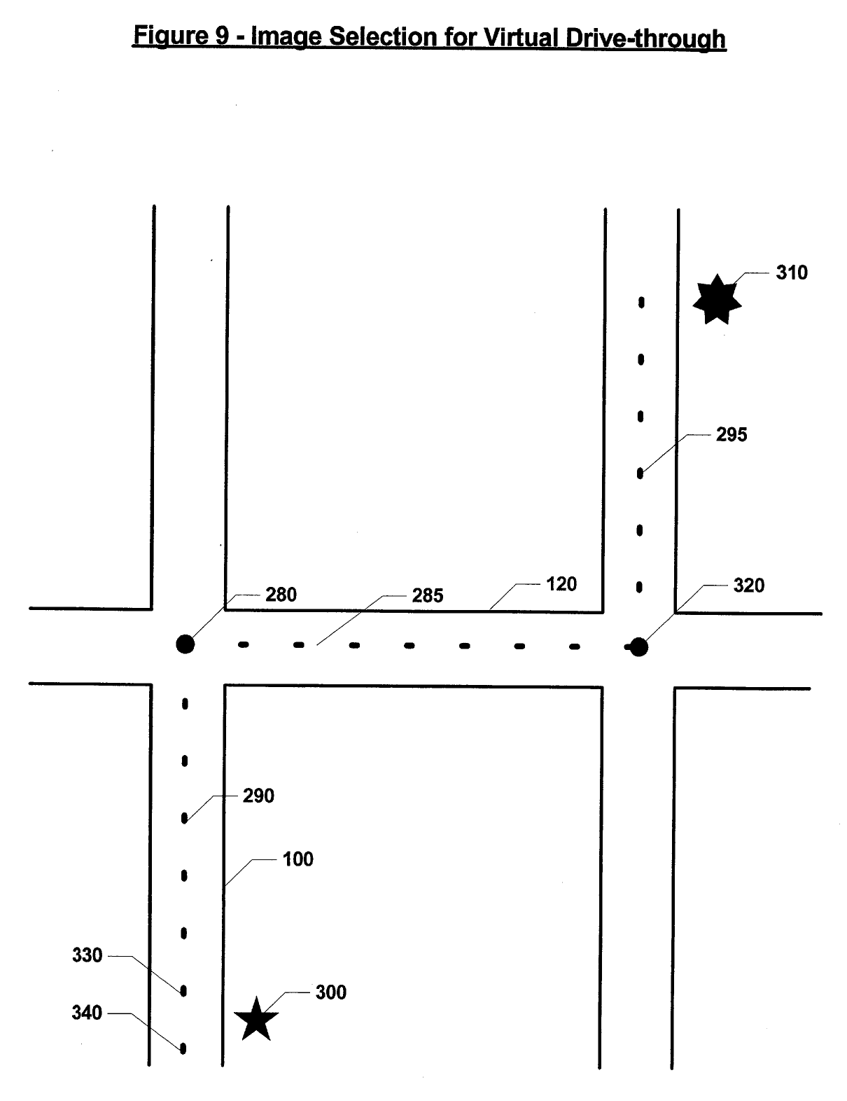

FIG. 8 shows the Spatial Node Header 500, which is used when the Image Header Data Structure 400 specifies that the present location is a Spatial Node 280. The Number of Turn Options 510 is an integer value that specifies the alternate runs that are available at the present location. For each option, the Spatial Node Header 500 preferably contains the Image Identifier 340 and the Location 410.

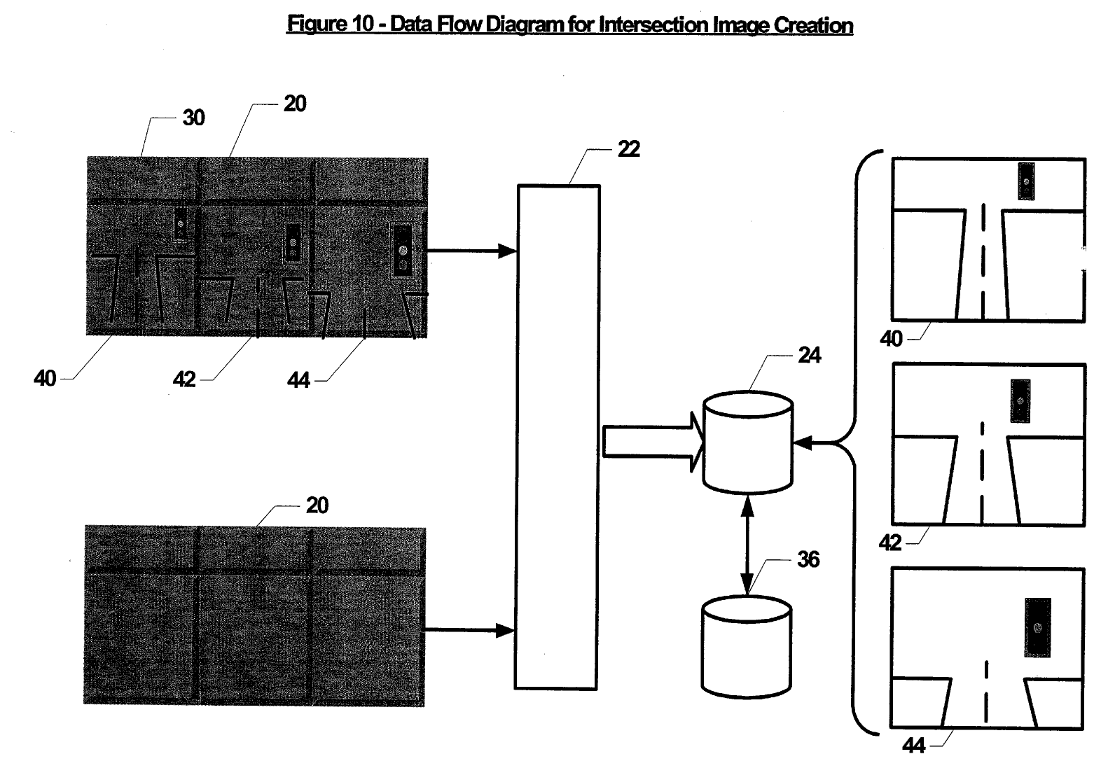

FIG. 9 shows the navigation of images from the origin 300 to the destination 310. When vehicle movement begins from the origin 300, the application will perform a spatial query on the spatial database 36 to determine the possible starting image locations 330, 340. Based on the desired direction of travel, the application will retrieve the appropriate image. The first image will have header information that specifies both the next landmark image for this run and the next Spatial Node for this run. The application, based on the user's parameters, can retrieve and display all images, only intersection images, or only intersection images where a vehicle turn must be made.

In one embodiment as shown in FIG. 10, the tagged image stream 20 is analyzed by a computer processor 22 to identify each intersection 30 in the portion of the roadway system being recorded, and an image database 24 is generated that includes at least one image 40, 42, 44 taken from the perspective of each road segment 32 approaching that intersection 30. In an alternate embodiment, the identification of intersections 30 for each road segment 32 and the corresponding generation of the intersection image database 24 is accomplished by the same processor 18 that tags the raw image stream 14. In another embodiment where individual intersection images are used, each individual image could already have intersection information directly associated with the image.

One example of the details for how a tagged image stream 20 can be acquired and processed to generate an image database 24 is set out in U.S. patent application Ser. No. 09/177,836, now issued as U.S. Pat. No. 6,266,442, entitled “Method and Apparatus for Identifying Objects Depicted in a Videostream,” the disclosure of which is hereby incorporated by reference.

It will be understood that the tagged image stream 20 and the raw image stream 14 may be reprocessed in a batch mode any number of times to generate different versions of the image database 24. For example, in the embodiment previously discussed in which landmark images for a sponsor are introduced into a sequence of images associated with a given run, the sponsored images in the sequence could be replaced on a periodic basis (e.g., weekly or monthly). Alternatively, the image database 24 could be recreated for each season or could be periodically updated, for example, on an annual or biannual basis to record new images that represent changes in the physical environment at a landmark image location that may have occurred.

Preferably, multiple images 40, 42, 44 are tagged that represent actual views of an intersection 30 at varying distances from the intersection 30 for each road segment approaching the intersection 30. These distances may be different for every intersection 30, and may often correspond to views that contain relevant signage, lane markings, or other important visual clues for that intersection. Preferably, a roadmap database 36 contains an identification of the GPS coordinates of each intersection 30 in that portion of the roadway. In a preferred embodiment, the GPS receiver 16 of the acquisition vehicle 12 is sufficiently precise to resolve unique lanes on a road or street into individual road segments, each road segment having an associated direction of travel.

While it is preferred that an on-board vehicle navigation system utilize a GPS or similar positioning system, it will be understood that there is no need for a positioning system on the vehicle in this invention, nor is there a need for an on-board display. The invention applies to both on-line and off-line access of intersection images and virtual drive-throughs. Although image streams are described, it will be understood that still images can also be used to generate the intersection image database 24. For road interactions that do not result in intersections (e.g., highway overpasses or freeway exits), the “intersection” images can be views of the relevant exit ramp, merging lanes or the like.

In one embodiment, the tagged image stream 20 is also processed to determine the location and identification of road signage 34 and this information is used as part of the image selection process. In this embodiment, information about the road signage 34 is utilized to determine whether the selected images contain all of the relevant road signage 34 that would be helpful to view for any actions that may occur at this intersection 30. Preferably, the information about road signage 34 in the tagged image stream 20 includes information for determining right-of-way information, speed limits, turn restrictions, and other relevant navigation parameters. If important road signage 34 is not present in one of the initially selected views, or if the initially selected view is obscured, the process will search for an alternative acceptable image. The location of road signage 34 can be used in this step to identify starting points for selecting the image distances to be used to show the desired road signage information.

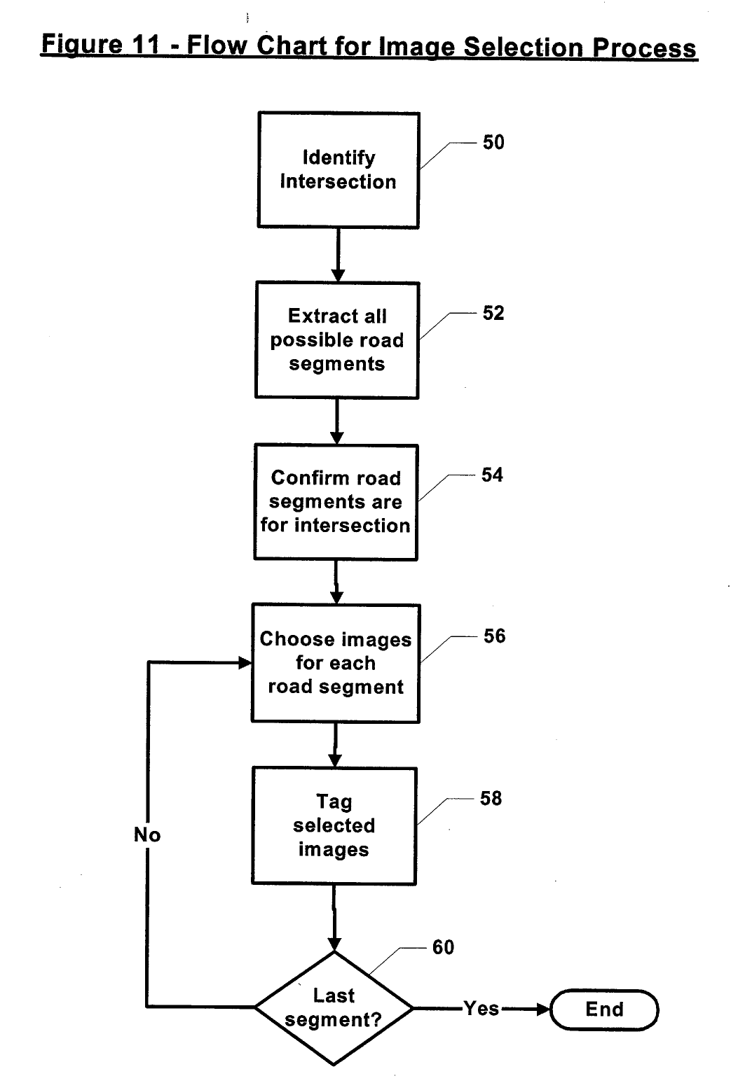

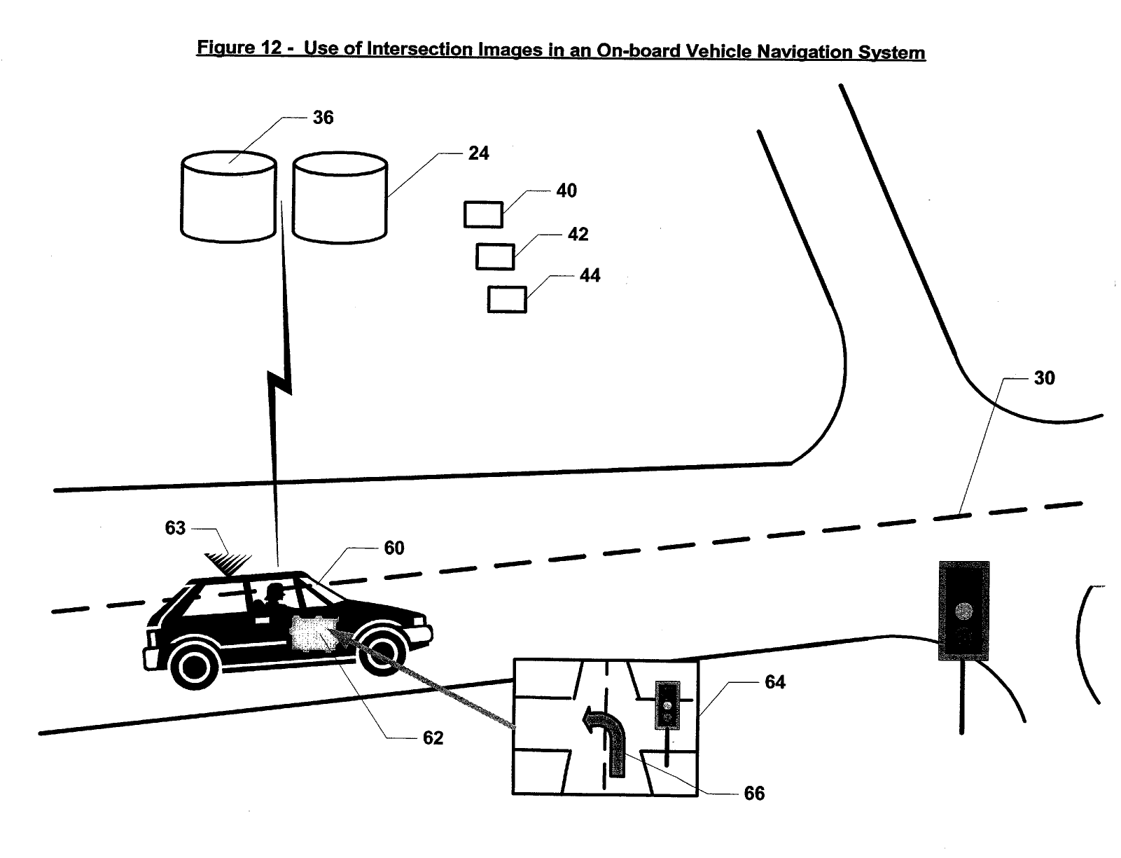

FIG. 11 shows a flow diagram of one embodiment of the image selection process used to generate an intersection image database or to tag intersection images within the image database 24. At step 50, the GPS location of an intersection 30 in a roadway system is identified. It will be recognized that the identification of all potential intersections 30 along with their corresponding GPS location in a given area can be accomplished in a number of ways. The GPS locations of desired locations can be entered manually, provided from a predetermined database, selectively recorded by an operator as the image acquisition vehicle travels through the intersection, translated from a map or satellite image, calculated in response to an automated image analysis of the tagged image stream that identifies likely intersection locations, or any combination of these or similar techniques. At step 52, all segments of the tagged image stream 20 having GPS locations values within a given radius of the GPS location are extracted from the tagged video stream. At step 54, the direction and perspective of each of these segments of tagged image stream 20 is determined to confirm that the segment represents actual views of each of the road segments 32 associated with that intersection 30. Preferably, the number, location, orientation and relationship of each road segment 32 is provided as part of the identification of potential intersections 30 at step 50. Alternatively, the tagged image stream 20 may be analyzed to determine the various characteristics of each road segment as part of step 54. At step 56, a set of images 40, 42, 44 are chosen to represent the actual view of one of the road segment 32 approaching that intersection 30. As previously described, the set of images 40, 42, 44 are analyzed in terms of visual presentation of relevant information, particularly relevant road signage 34. In one embodiment where information about road signage 34 is maintained in an automated database, the selection of images 40, 42, 44 preferably can be automated in relation to the database of road sign images. In a preferred embodiment, step 56 initially selects three image distances of 15, 30, 60 meters from the intersection 30. At step 58, the selected images are stored in the intersection image database 24 as the representative prerecorded intersection images for that road segment 32 for that intersection 30. At step 60, the process is repeated until all of the road segments 32 for a given intersection 30 have been processed.

It will be understood that the actual selection of the images in step 56 can be done either automatically by the computer processor or can be assisted by an operator. Preferably, the prerecorded images 40, 42, 44 in the intersection image database 24 are single frame images so as to minimize the overall size of the intersection image database 24. It will also be understood that any number of image/data compression techniques can be utilized to further reduce the amount of storage required for intersection image database 24. Alternatively, the prerecorded images 40, 42, 44 may be multiple frames or even video segments. It will also be understood that the intersection images 40, 42, 44 do not necessarily need GPS location information. By tagging images to a route (current road of travel), an intersection (name of cross street), and a direction of travel on the route, these images can have the same usefulness as GPS-tagged images.

In another embodiment, the intersection image database 24 can be provided with multiple images 40, 42, 44 corresponding to the same road segment 32 or the same intersection 30 where the different sets of images represent different conditions at the intersection. For example, one set of images could correspond to the intersection during the day and another set of images could correspond to the intersection at night. Alternatively, one set of images could correspond to the intersection during each of the seasons. These multiple sets of images 40, 42, 44 can be obtained by processing another tagged image stream 20 or individual intersection images representing these different conditions, or they can be generated by altering the original set of images to simulate different conditions.

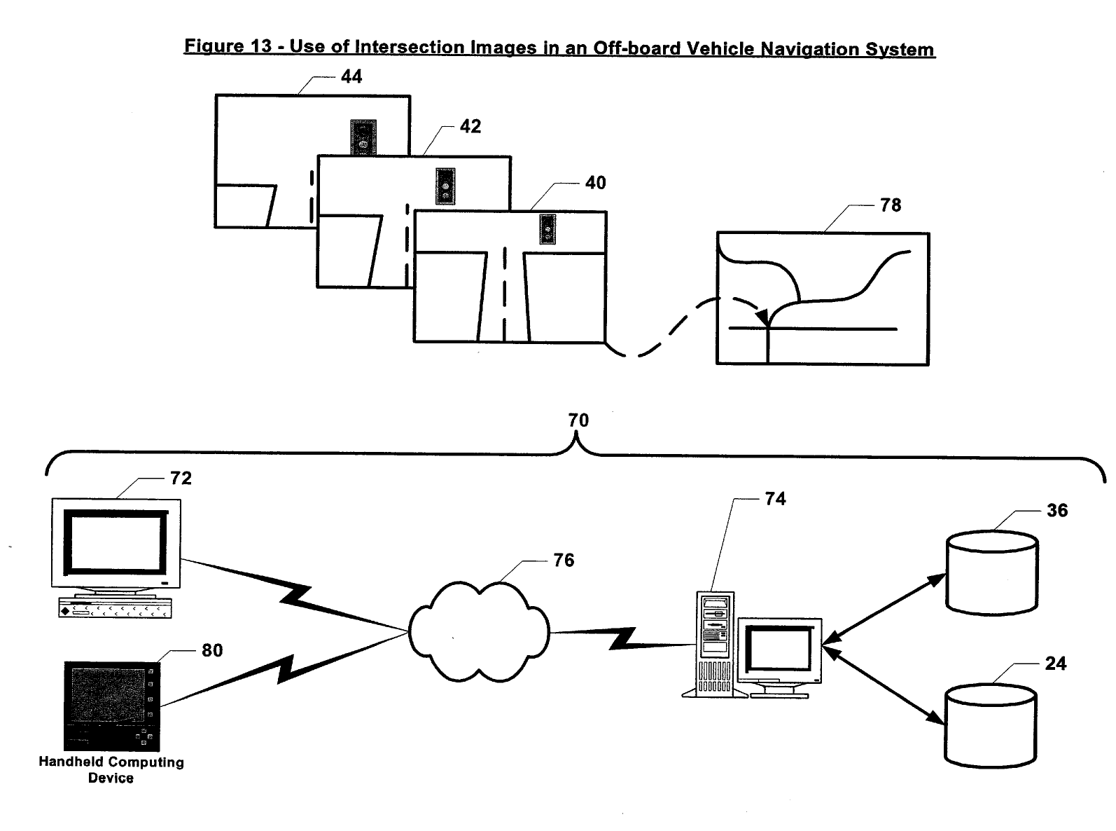

FIG. 12 shows one embodiment of a vehicle 60 having an on-board vehicle navigation system 62 incorporating the present invention. The operator requested a route from the origin of the trip to the destination. When the trip request was made, the navigation system made a request over a wireless network to the routing database 36. The information returned to the navigation system 62 included the list of intersections along the route to be traveled along with the first image of the roadway to be traveled. Having made this routing request, the navigation system 62 will require no further requests for information from the routing database 36. All future image requests can be made directly to the image database 24. Before the vehicle 60 approaches an intersection 30 at which a driver action is required, the on-board vehicle navigation system 62 requests the prerecorded images 40, 42, 44 from the image database as well as the spatial node image corresponding to the intersection. As the vehicle approaches the intersection, the navigation system will update the shown image to give the driver visual cues regarding the impending turn. The information from the spatial node will allow the system to request the first image from the new run once the left turn is made. The new image will contain all of the information needed to collect the proper images for the next intersection.

It will be understood that many variations can be made in the manner in which the on-board vehicle navigation system 62 accesses the intersection image database 24. In one embodiment as shown, a telecommunications communication link is established between the vehicle 60 and a land-based facility. In another embodiment, the intersection image database 24 may be stored on CDROM, DVD or the like and accessed within the vehicle 60. For on-line systems, position information can be supplied to the vehicle navigation system 62 via any of the following methods: voice recognition of driver commands; scrolling of a list of images or image icons on a display; distance measurement indicator on the vehicle; inertial navigation unit contained on the vehicle; inertial navigation unit contained within the navigation system, but not installed on the vehicle.

FIG. 13 shows an embodiment of the present invention as used in conjunction with an off-board navigation system 70. A user interacts with a client 72 to initiate a request for map information to a server 74 across a network 76 such as the Internet. The server 74 has access to the road map database 36 and the image database 24. Once the server 74 has determined a base map 78 in response to the user's request, intersection images 40, 42, 44 associated with an intersection on the navigation route can be selectively displayed to the user. The base map 78 can be a navigation route as determined by the server 74 or can simply be a given road map section corresponding to a selected area.

Many different embodiments of how the image database 24 can be accessed and images 40, 42, 44 displayed are possible. In one embodiment, a user could identify an intersection on a 2-D base map. The software application accessing the intersection image database 24 requests the entrance road for the intersection and the direction of travel. The application will then request the exit road from the intersection and the direction of travel. Images 40, 42, 44 would be selected showing all driver decision points for that intersection along with arrows showing vehicle path. In another embodiment, a user could specify two roads that intersect. The application would request the entrance road for the intersection and the direction of travel, as well as the exit road from the intersection and the direction of travel. In one embodiment, images can be displayed showing all driver decision points for that intersection along with arrows showing vehicle path. The “user” in this embodiment can be another application that has generated directions from a source to a destination. In a different embodiment, a user identifies a route on a 2-D base map on a road. Once the application is provided with the direction of travel, the application can display all images corresponding to driver decision points for the next intersection along the specified road's direction of travel.

1. An automated method of using pre-recorded images as part of a computerized navigational system to acquaint a user with intersections and other points of interest along a selected route, comprising:
selecting a set of landmark images from a multiplicity of pre-recorded images; and
processing the selected landmark images with header information to associate the selected landmark images to a set of spatial nodes based on a plurality of pre-defined routing runs such that the automated navigation system can separately process the selected route and the set of landmark images by using the header information associated with the set of landmark images.

2. The method of claim 1 wherein the step of selecting the set of landmark images comprise selecting at least one landmark image taken from a non-aerial perspective of an approaching road segment for each approaching road segment.

3. An automated navigation system that displays selected ones of pre-recorded images to acquaint a person with intersections and other points of interest along a selected route, comprising:
an image database containing a set of landmark images selected from a multiplicity of pre-recorded images, the set of landmark images including header information processed to associate the landmark images to a set of spatial nodes based on a plurality of pre-defined routing runs;
a routing database;
means for generating a desired routing run using the routing database means for displaying images associated with the routing run by separately processing the image database based upon the header information associated with the set of landmark images contained in the image database.

5. A method of using pre-recorded images as part of an automated navigational system to acquaint a user with approaching intersections and other points of interest, comprising:
creating a set of routing runs correlating to a path or road segment to be traveled, whereby a transition point from one run to another is defined by a spatial node;
selecting a set of images corresponding to landmarks along the roadway system from a multiplicity of pre-recorded images;
processing the set of selected images to generate header information to associate the images with the spatial nodes based on the routing runs;
recording the processed images and the header information in an image database.

6. The method of claim 5 further comprising:
generating a given route from among the set of routing runs; and
accessing the image database based on the header information to select images to be displayed for the given route.

7. The method of claim 6 wherein the steps of creating the given route and accessing the image database are performed by an on-board vehicle navigation system.

8. The method of claim 6 wherein the steps of creating the given route is performed by a processing system other than an on-board vehicle navigation system.

9. The method of claim 6 wherein the step of accessing the image database is performed by accessing the image database through the Internet.

10. The method of claim 6 further comprising the step of displaying the selected images for the given route at a controlled rate.

11. The method of claim 5 further comprising updating the image database on a periodic basis in an offline manner by:
selecting a new set of landmark images;
defining a new set of spatial nodes; and
processing the set of selected images to generate header information to associate the images with the spatial nodes based on the routing runs;
